(19) United States
(12) Patent Application Publication
(10) Pub. No.: US 2025/0124324 A1
(43) Pub. Date: Apr. 17, 2025

(54) Intelligence Systems for Quantum-Infused Grading and Optimization Methods for Software Programs

(71) Applicant: Bank of America Corporation, Charlotte, NC (US)

(72) Inventors: Gunjan Jaiswal, Mumbai (IN); Jyothi Gaddam, Hyderabad (IN); Susmitha Kunchanapalli, Chennai (IN); Durga Prasad Kutthumolu, Hyderabad (IN)

(21) Appl. No.: 18/379,311

(22) Filed: Oct. 12, 2023

(51) Int. Cl. G06N 10/60; G06N 10/20

(52) U.S. Cl. CPC G06N 10/60; G06N 10/20

(57) ABSTRACT

An automated solution is provided through quantum computing, AI/ML algorithms, neural networking, and hybrid computing integration in order to provide end-to-end optimization software programs. The system may be implemented by generating unique grade(s) for software program(s) against disparate behavior using quantum computing. Quantum entanglement and superposition will ensure fast calculation and analysis of every code snippet. The grade can be further utilized by classical computing engines, which can operate in layers to generate an intelligent report highlighting granular deviation and select an optimized version of program through decision making algorithms, which can then be integrated to original version after passing validity/compatibility checks and automatically employed.

### TECHNICAL FIELD

The present disclosure relates to data processing: software development, installation, and management with respect to software program development tools for quantum-infused grading and optimization methods (e.g., integrated case tools or stand-alone development tools), comprising means or steps operating on a computer or digital data processing system that enables the creation and management of computer program code that is more efficient with respect to a performance parameter such as speed, memory usage, security, or other resource usage, through the selection and design of data structures and algorithms.

### DESCRIPTION OF THE RELATED ART

Achieving and maintaining an optimized behavior for software programs with respect to program performance, risk, and vulnerabilities is a never-ending problem and major challenge in industry. Problems can be caused based on long running batch jobs, inefficient coding, risk issues, open vulnerabilities or slow responses of a real time application. The problem is real and troublesome.

There can be multiple reasons why program performance gets affected or security violations occur over time. There could be an increase in load, incorrect methods or processes for coding, infrastructure issues, or other resource management issues.

As an example, a web application may have performance issues such as it is lagging and its response time is delayed. Alerts can be generated and statistics can be provided. A developer can then manually investigate the issue, identify the problem, develop potential solutions, and pick whichever looks like the best one.

This entire process is usually manual and consumes a substantial amount of time. And, by the time the potential solution is about to be deployed, yet another issue may be identified. This requires that the entire manual process be repeated to find a new solution.

The challenge is to continuously monitor programs for their optimal behavior (against all metrics) and then identify and fix the problems, bottlenecks, errors, or the like. Moreover, there is no standard quantifier for measuring the programs across all platforms. There are no technology independent integration platforms that can improve program behavior in all aspects.

Hence, there is a long felt and unsatisfied need to, inter alia, to automate an entire software optimization lifecycle.

### SUMMARY OF THE INVENTION

In accordance with one or more arrangements of the non-limiting sample disclosures contained herein, solutions are provided to address one or more of the shortcomings in the field of software monitoring and optimization lifecycles by, inter alia, (a) providing a solution to automate an entire optimization lifecycle using a hybrid computing engine by monitoring, grading and enhancing software program functioning; (b) using a quantum computing engine to leverage benefits of quantum superposition and interference to execute a scoring formula for grading the programs against their disparate behaviors (performance, risk, security, cost etc.); (c) converting the scoring formula to quantum circuits so the score will be computed quickly; (d) utilizing a grading AI/ML predictive and recommendation engine to generate an intelligence report suggesting optimized solutions; and (e) integrating the optimized programs into existing applications after compatibility is confirmed and standard checks are performed, thereby automating the entire optimization cycle.

The inventions contained herein provide a number of novel features and benefits including, but not limited to: 1) the concept of uniquely grading software program for its multiple behavioral aspects; 2) the integration of quantum and classical computing powers to generate the most efficient program optimization; 3) using a grading formula (for both sample and batch data) which will be converted to quantum circuit using cQASM/QASM (quantum program language); 4) quantum grading engine leveraging benefits of quantum superposition and interference to execute the algorithm for grade calculation; 5) dynamic comparison of latest program statistics with the defined standards in form of qubits and inducing unique grade; 6) a regression AI model that predicts threshold values of program metrics based on processing datasets; 7) use of quantum mechanics to perform granular level comparison of parameter statistics with threshold values; 8) an automated system to capture runtime statistics of the software program and storing it in a structured format; 9) a modern illustrative algorithm engine discovering the patterns, deviations, correlations and thus giving predictive analysis on area which needs optimization; 10) an intelligent report generated with the optimized version of the solution; 11) use of advanced neural network algorithms to scan the code and suggest fixes through knowledge graph and weighing computation; 12) implementing a proposition engine driven by a decision algorithm to intelligently selects the solution or combination of solution based on grade deviation and cost efficiency; 13) implementing a continuous monitoring and evaluating system, which will monitor actual and optimized programs; and 14) automating a complete optimization lifecycle, end to end.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Nor is it intended to imply or require that any such steps or elements, in this summary or elsewhere in this disclosure, be implemented or executed in any particular order. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, an automated solution is provided through quantum computing, AI/ML algorithms, neural networking, and hybrid computing integration in order to optimize software programs. The system may be implemented by generating unique grade(s) for software program(s) against disparate behavior using quantum computing. Quantum entanglement and superposition will ensure fast calculation and analysis of every code snippet. The grade can be further utilized by classical computing engines, which can operate in layers to generate an intelligent report highlighting granular deviation and select an optimized version of program through decision making algorithms, which can then be integrated to original version after passing validity/compatibility checks.

In some arrangements, one or more various steps or processes disclosed herein can be implemented in whole or in part as computer-executable instructions (or as computer modules or in other computer constructs) stored on computer-readable media. Functionality and steps can be performed on a machine or distributed across a plurality of machines that are in communication with one another.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts a sample, functional, architectural diagram with flow functionality conceptually showing sample interactions, steps, functions, and components in accordance with one or more aspects of this disclosure.

FIG. 2 depicts a sample, functional, technical diagram (including quantum grading) with flow functionality conceptually showing sample interactions, steps, functions, and components in accordance with one or more aspects of this disclosure.

FIG. 3 depicts a sample, functional, technical diagram (regarding engine optimization) with flow functionality conceptually showing sample interactions, steps, functions, and components in accordance with one or more aspects of this disclosure.

FIG. 4 depicts a sample, functional, use case with flow functionality conceptually showing sample interactions, steps, functions, and components for web application performance optimization in accordance with one or more aspects of this disclosure.

FIG. 5 depicts a sample, functional flow diagram discussing flow functionality in intermediate architecture detail and conceptually shows sample interactions, steps, functions, and components in accordance with one or more aspects of this disclosure.

### DETAILED DESCRIPTION

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, any number of computers, machines, or the like can include one or more general-purpose, customized, configured, special-purpose, virtual, physical, and/or network-accessible devices such as: administrative computers, application servers, clients, cloud devices, clusters, compliance watchers, computing devices, computing platforms, controlled computers, controlling computers, desktop computers, distributed systems, enterprise computers, instances, laptop devices, monitors or monitoring systems, nodes, notebook computers, personal computers, portable electronic devices, portals (internal or external), servers, smart devices, streaming servers, tablets, web servers, and/or workstations, which may have one or more application specific integrated circuits (ASICs), microprocessors, cores, executors etc. for executing, accessing, controlling, implementing etc. various software, computer-executable instructions, data, modules, processes, routines, or the like as discussed below.

References to computers, machines, or the like as in the examples above are used interchangeably in this specification and are not considered limiting or exclusive to any type(s) of electrical device(s), or component(s), or the like. Instead, references in this disclosure to computers, machines, or the like are to be interpreted broadly as understood by skilled artisans. Further, as used in this specification, computers, machines, or the like also include all hardware and components typically contained therein such as, for example, ASICs, processors, executors, cores, etc., display(s) and/or input interfaces/devices, network interfaces, communication buses, or the like, and memories or the like, which can include various sectors, locations, structures, or other electrical elements or components, software, computer-executable instructions, data, modules, processes, routines etc. Other specific or general components, machines, or the like are not depicted in the interest of brevity and would be understood readily by a person of skill in the art.

As used throughout this disclosure, software, computer-executable instructions, data, modules, processes, routines, or the like can include one or more: active-learning, algorithms, alarms, alerts, applications, application program interfaces (APIs), artificial intelligence, approvals, asymmetric encryption (including public/private keys), attachments, big data, blockchains, blocks, CRON functionality, daemons, databases, datasets, datastores, DeFi functionality, drivers, data structures, deep learning modules (e.g., knowledge graphs, NLP, LSTM, GAN, etc.), distributed ledgers, distributed-ledger blockchains, dynamic rule engines, emails, extraction functionality, file systems or distributed file systems, firmware, governance rules, graphical user interfaces (GUI or UI), images, instructions, interactions, Java jar files, Java Virtual Machines (JVMs), juggler schedulers and supervisors, load balancers, load functionality, machine learning (supervised, semi-supervised, unsupervised, or natural language processing), metadata, middleware, modules, namespaces, objects, operating systems, optimization modules, platforms, processes, protocols, programs, rejections, routes, routines, rule deployment modules, security, scripts, tables, tools, transactions, transformation functionality, user actions, user interface codes, utilities, web application firewalls (WAFs), web servers, web sites, etc.

The foregoing software, computer-executable instructions, data, modules, processes, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like (e.g., in a decentralized network that may include a consortium of networks, entities, institutions, etc.) including memory and other components thereof. Some or all the foregoing may additionally and/or alternatively be stored similarly and/or in a distributed manner in the network accessible storage/distributed data/datastores/databases/big data/blockchains/distributed ledger blockchains etc.

As used throughout this disclosure, computer “networks,” topologies, or the like can include one or more local area networks (LANs), wide area networks (WANs), the Internet, clouds, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may utilize any transport that supports HTTPS or any other type of suitable communication, transmission, and/or other packet-based protocol.

As used herein, hybrid refers to partially remote and partially local. For example, quantum computing at supercomputer facilities is almost always going to be remote since the number facilities with such capabilities is very low. Further, use of such resources is likely quite expensive, and availability is likely limited. In addition, hybrid refers to implementation wherein the most demanding portion of the computing is performed by quantum computing and the remaining portion is handled by classical computing or traditional computing hardware and optimization engines implemented thereon.

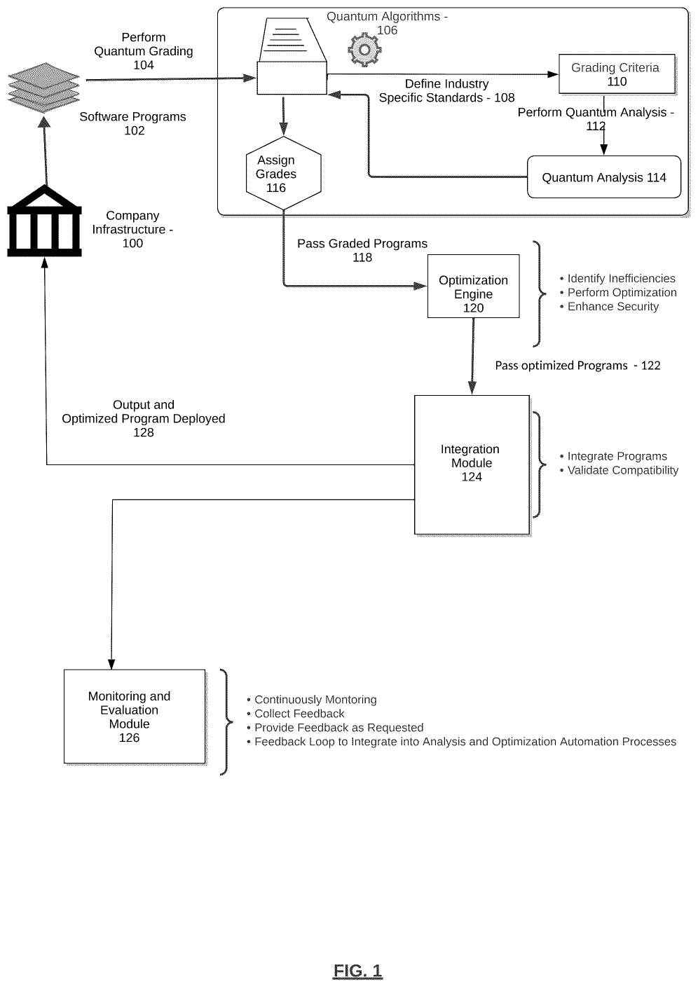

By way of non-limiting disclosure, FIG. 1 depicts a sample, functional, architectural diagram with flow functionality conceptually showing sample interactions, steps, functions, and components in accordance with one or more aspects of this disclosure.

A combinational integration of quantum and classical computing powers can be used to generate the most efficient optimization(s) for software programs 102, which a company 100 may have operational and executing in series or parallel. The software program could be any set of programs/codes executed for any application-it could be an online application, a batch job, programs used in trading platform, risk assessment or compliance platform, automation testing script, etc. Basically, it can be any code piece which is written in any language/tool to perform some exercise.

For each program being executed that is to be optimized, quantum grading 104 can be performed using one or more quantum algorithms 106. This is the concept of uniquely grading the software program for its multiple behavioral aspects. In performing the quantum grading, the grading engine will leverage the benefits of quantum superposition and interference to execute the algorithm for calculating a score. It can dynamically compare the latest program statistics with the defined standards and creates deviation with respect to priority, which in return can induce a grade on a liner scale. Thus, a unique number can be assigned to each aspect of program, based on calculations through quantum analysis, which helps in identifying the degradation of performance or risk aspects of program.

A standard value for each metric will be setup for an application based on industry standard(s). This benchmark value will be calculated by running a ML model against a variety of datasets. Defined industry specific standards 108 for scoring can be used in order to generate application grading or scoring criteria 110.

This first starts with quantum analysis 112, which can be performed on the applications under scrutiny by use of a quantum analysis module 114. The results of the quantum analysis can then be used to assign grades 116 to the programs. This can be accomplished by using a grading formula for both sample and batch data that will be converted to a quantum circuit using a quantum program language (cQasm).

In addition to grading, the quantum computing engine will perform grade deviation analysis at granular level to identify the exact problem and by taking benefit of quantum entanglement, closest possible solution will be suggested swiftly.

The graded program can be passed to a classical computing engine, which can identify and segregate the suggestion and generate a report. The report can have the particulars of all the characteristics identified in code or other metric analysis in order to identify inefficiencies or issues. It can highlight the coding inefficiency for an incorrect way of writing, unwanted/redundant pieces, incompatible supporting libraries, etc.

This hybrid model of quantum computing merged with classical optimization provides a unique combination that maximizes performance and security while minimizing cost. The potential program solutions that satisfy the criteria threshold can be passed 118 to an optimization engine 120. The optimization engine 120 can identify inefficiencies in the programs, perform further optimization, improve security, etc. Regarding performing optimization, based on the possible solution provided by the quantum engine, the classic optimization engine can select the most optimized solution using a heuristic approach. In order to enhance security, the engine will also examine the risk grade and respective proposition by graded engine and will select the most appropriate fixes for overcoming performance/risk/security threats. For optimization, the existing program can be embedded with all the predetermined solutions. An optimized version of program can be generated only if the grade is degraded and is lower than the designed threshold.

Optimized programs can be passed in 122 to an integration module 124. In other words, the new updated optimized program (if generated) will then be passed to the next step for seeking approvals and performing compatible checks. The integration module can integrate the one or more solution programs and validate compatibility with the environment and other programs being executed. The modified program can pass through the compatibility test that will validate whether the suggestions are as per company standards or are agreeable by business users and infrastructure.

The integration module can the output the results and pass the optimized program for deployment in 128. Concurrently and subsequently thereafter, a monitoring and evaluation module 126 can continuously monitor the newly deployed program(s), collect feedback, provide feedback as requested, and can integrate feedback into analysis and optimization automation processes as a form of machine learning to improve future analyses and optimizations.

Regarding continuous monitoring, the program can be continuously monitored by quantum engine and even the optimized version can be monitored for some time to identify any possible inefficacy. For monitoring and evaluation, as part of evaluation, the newer version of program can be monitored and evaluated against test datasets using complex ML simulations of quantum computing. This will keep on adding the suggested comments into the intelligent report and any new bug/inefficacy can be resolved timely.

The collected feedback in terms of approval and evaluation stats can be collected and stored. Regarding output of the graded and optimized program, once approved, the newly optimized program will be output and integrated to the existing channel, completing the whole optimization lifecycle. This new program will again be monitored and evaluated continuously.

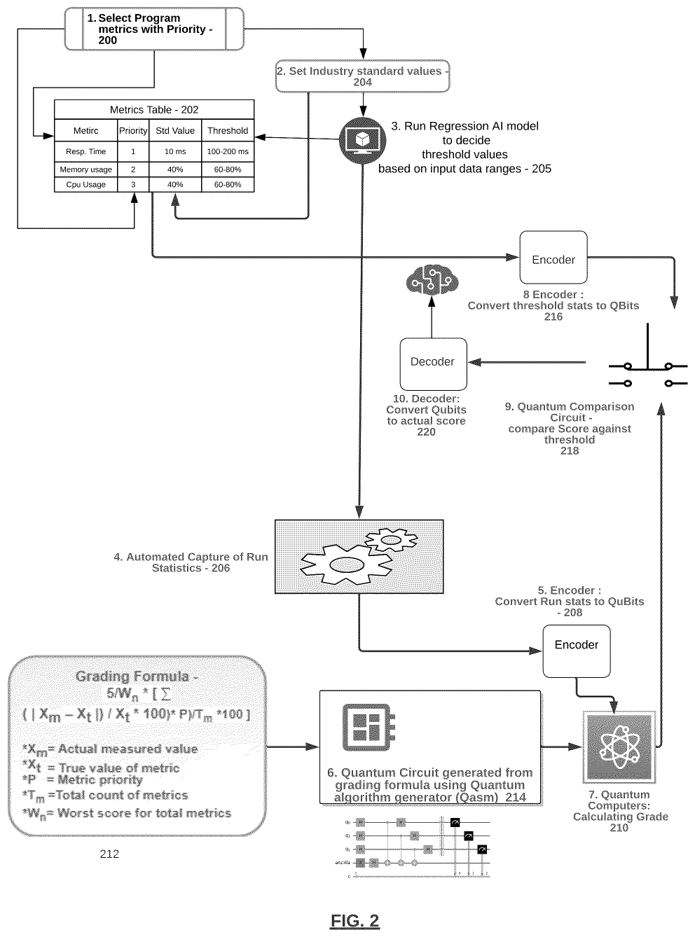

By way of non-limiting disclosure, FIG. 2 depicts the first portion of a sample, functional, technical diagram (including quantum grading) with flow functionality conceptually showing sample interactions, steps, functions, and components in accordance with one or more aspects of this disclosure.

The first step 200 is to select the program metrics to be used to grade the program along with the priority to be applied for those metrics. Sample metrics, like depicted in the metrics table 202, can include response time, memory usage, CPU usage, DNS lookup time, time to failure, web application parameters, etc.

The metrics table 202 can be adjusted to omit metrics that should not be monitored, assigned priorities for those that should be checked and monitored, etc. As depicted in this example, the metrics to be monitored are response time, memory usage, and CPU usage, which respectively were assigned priorities of 1, 2, and 3. Higher priority values can instruct the system to monitor the metric more vigorously and afford more weight to even slightest changes in values. In this example, response time has a priority of 1; therefore, the response time will be monitored very closely and even a slight change in response time will result in higher deviation value based on the weight assigned to the higher priority in the grading system.

In industry or within a company, there are often standards for every parameter. They can be manually set or retrieved 204 from a datastore or the like as desired for each selected metric/parameter. They may be incorporated into the metrics table 202 as shown in the figure. As shown in the example in the figure, the standard for response time for an application could be 10 ms.

A regression AI model 205 can be run to predict threshold values of program metrics based on processing datasets for input data ranges in 206. The regression AI model is a machine learning model that is used to predict continuous values. This is in contrast to classification AI models, which are used to predict discrete categories. Sample regression AI models that may be used include: linear regression, polynomial regression, ridge regression, lasso regression, support vector regression, decision trees, random forests, gradient boosting machines, and neural networks.

The threshold values for the parameters may be incorporated into the metrics table 202 as well. The thresholds can be the range against which incoming values are compared. Models can be used that predict this range based on the input data. This calculates the optimized range for each parameter.

The output of the regression AI model can be used in conjunction with the automated capture of runtime statistics in 206 corresponding to program execution. This will identify the runtime values for the prioritized metrics.

The runtime statistics are converted to quantum bits (a/k/a qubits) and encoded in 208. The quantum equivalent of traditional binary bits (i.e., a “0” or “1”) is called a qubit. A qubit can, however, be in a superposition of both states simultaneously, unlike a traditional bit. This indicates that a qubit can represent more data than a traditional bit. Entanglement, in which two or more qubits are connected so that they share the same fate, is one of the most significant characteristics of qubits. Even if they are physically apart, you can quickly determine the state of the other entangled qubits if you measure the state of one of them. One of the main elements that gives quantum computers their significant capability is entanglement. It enables quantum computers to carry out some computations far more quickly than conventional computers.

One of the quantum computing inputs for calculating the grade in 210 is the encoded runtime statistics from encoder 208. The other input is from the grading formula 212, which can be, as an example, 5/Wₙ*[Σ(|Xₘ−Xₜ|)/Xₜ*100)*P)/Tₘ*100], wherein: Xₘ=Actual measured value; Xₜ=True value of metric; P=Metric priority; Tₘ=Total count of metrics; and Wₙ=Worst score for total metrics.

A quantum circuit can be generated from the grading formula in 214 using a quantum algorithm generator (QASM), which is a tool that can be used to generate QASM code for a variety of quantum algorithms. QASM is a text-based programming language for describing quantum circuits. It is used by quantum computer compilers to generate machine code that can be executed on quantum hardware. Based on the two inputs, the quantum computer calculates a grade for the proposed solution in 210. For example, a grade can be calculated on a scale of 0 to 5 or the like. The calculated score can be a computation of the standard deviation or other metric.

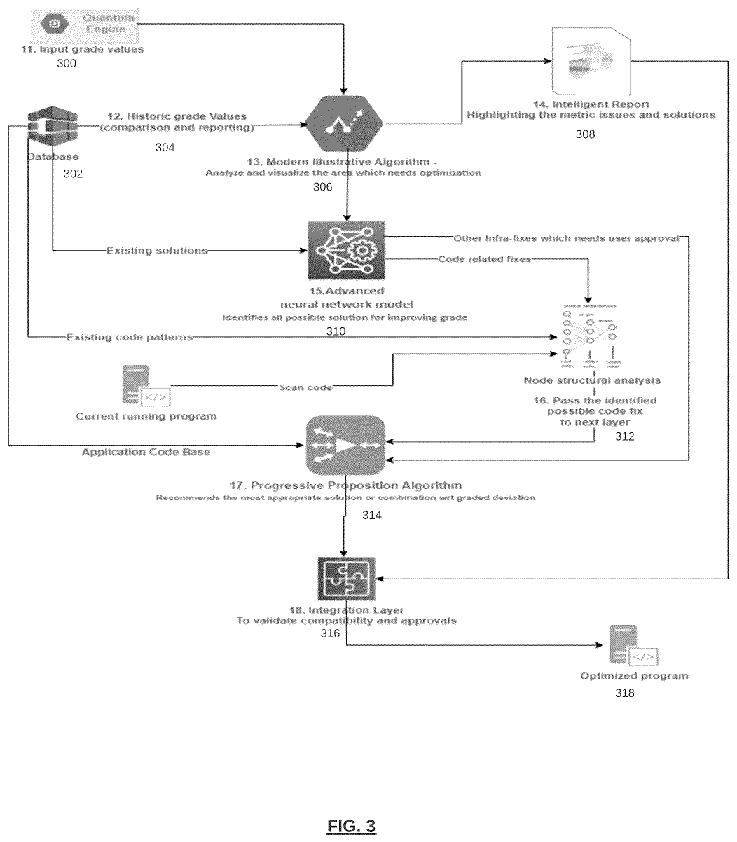

In 216, the threshold statistics from the metrics table 202 can be converted to qubits by an encoder. The qubits can then be provided to a quantum comparison circuit in 218 along with the final grading results from the quantum computer in 210 in order to compare the score against the threshold. The output can be provided to a decoder in 220 to convert the qubits into an actual score. This can then, in turn, be provided as input for optimization in 300 in FIG. 3 in order to suggest a solution that optimized and cost effective.

By way of non-limiting disclosure, FIG. 3 depicts the second part of a sample, functional, technical diagram (regarding engine optimizer) with flow functionality conceptually showing sample interactions, steps, functions, and components in accordance with one or more aspects of this disclosure.

As noted above, the created input grade values are provided in 300 from the output of the quantum engine technical diagram illustrated in FIG. 2.

As an example, assume that the quantum engine has computed that the final score is degraded by 20% based on response time, then optimization is required to remedy this 20% deficiency.

In 306, analysis and visualization of the areas which need optimization is performed by a modern illustrative algorithm. This analyzes the granular deviation of graded metrics by comparing it against historical grades and threshold values. And will generate an intelligent report 308 highlighting the troublesome metric, which, in this example, is the response time. This intelligent report 308 enables the user to visualize the deviation. In order to do this, historic graded values are retrieved from database 302 and provided for comparison and reporting in 304 to the algorithm 306. This is the first role of the optimization engine.

The second part is the advanced neural network model, which will identify all the possible solutions around problematic metric and perform code scanning and apply fixes through knowledge graphs (node structural analysis). Output from 306 regarding the area(s) that need optimization is provided to the advanced neural network model in 310 that identifies all possible solutions for improving the grade. This accomplished by retrieving existing solutions from database 302. The advanced neural network model is preferably a trained engine. It will identify the possible solutions that can address particular metric issues.

Sample potential solutions could be to evaluate the server if there are automatic scaling capabilities to compress the image sizes in the web application. Database queries can be optimized and can generate a number of potential solutions. For example, one might be infrastructure related issues and the other could be coordinated issues.

Suggested code related fixes can be provided by the advanced neural network model 310 along with existing code patterns from the database to a node structural analysis module in 312. Comparing against existing code patterns enables identification of the exact problem inside the code and the corresponding solution.

The algorithm will assign the labels or classes to each piece of input code and organize the code into a nodal model. Then with the help of nodal structure analysis a possible code fix will be identified and passed to the next layer.

Based on the application code base, infrastructure fixes from the neural network model, and possible code fixes from node structure analysis, a progressive proposition algorithm in 314 recommends the most appropriate solution or combination thereof based on grade deviation. The quantum proposition algorithm 314 will calculate the weight for each possible solution based on optimization weight and cost efficiency and then recommend the best combination which makes grade deviation to zero using a quantum approximate optimization algorithm.

Output from 314 is passed to an integration layer in 316 in order to validate compatibility and obtain user approvals if desired. Once validated and approved, the optimized program 318 is available for deployment. The integration layer can seek user approval for infrastructure related changes and implement the optimized version of program after passing validation.

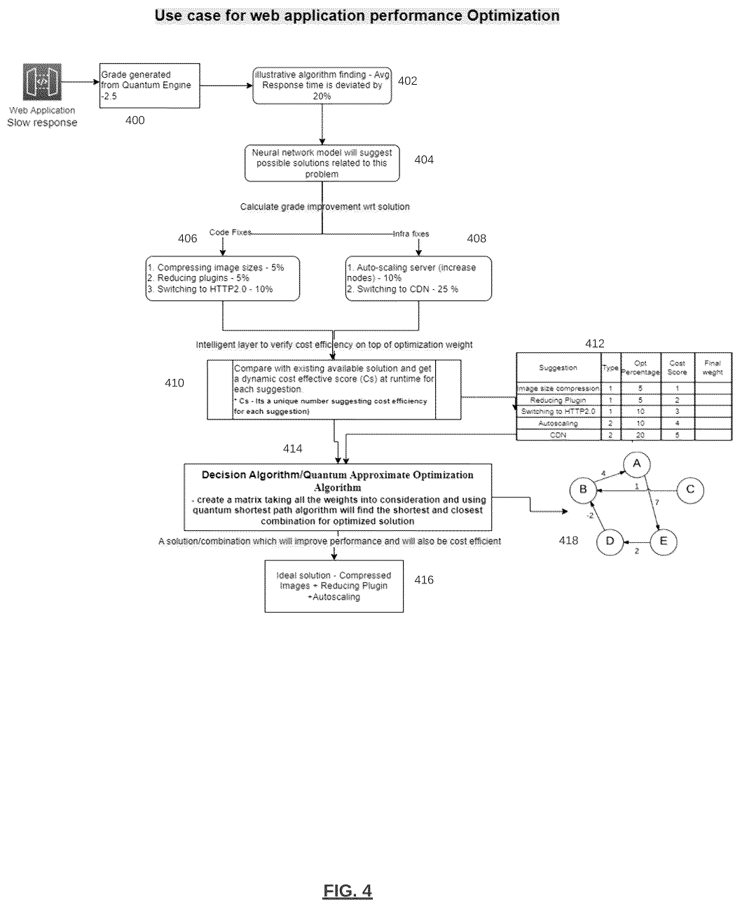

By way of non-limiting disclosure, FIG. 4 depicts a sample, functional, use case with flow functionality conceptually showing sample interactions, steps, functions, and components for web application performance optimization in accordance with one or more aspects of this disclosure.

An issue such as slow response time may be identified for a web application. A grade can be generated from a quantum engine in 400. The illustrative algorithm may find that the average response time is deviated by 20% in 402.

A neural network model will suggest possible solutions for the slow response time in 404 and will calculate grade improvement with respect to types of solutions. In this scenario, the neural network model has presented two types of solutions: code fixes 406 and infrastructure fixes 408.

For each of the potential solutions, the model has provided percentage improvements. This can be accomplished by simulating the quantum computing grading formula.

In 410, this can be provided to the intelligent layer to verify cost efficiency on top of the optimization weight. This is a comparison with existing available solutions to obtain a dynamic cost-effective score at runtime for each suggestion as indicated in 412. Based on the cost score and optimization percentage improvement, final weights and rankings can be provided. This enables the best solution and/or solution combinations to be selected.

In 414 a decision algorithm/quantum approximate optimization algorithm can create a matrix taking all the weights into consideration and using the quantum shortest path algorithm 418 to find the shortest and closest combination for an optimized solution.

Thus, a solution/combination that will improve performance and be cost effective can be identified in 416. In the example provided, the ideal solution would be to compress images and reducing plugins and autoscaling.

Once the optimized program is identified, the process can proceed with integration. In other words, the problem was identified and a solution was generated. Next the solution needs to be integrated into the existing program (e.g., web application) in the system.

It is possible that an application owner will not approve the solution because it is not compatible with company standards or for some other reason. So the integration module allows for user input approvals. Validation and compatibility can then be tested.

A parallel instance of an application can be executed in a test environment with the optimized version of the code to verify that the changes are working and that other issues have not been created. If this verification passes and the user approves, the optimized solution can be deployed.

Thus, this disclosure enables automating the entire optimization cycle from problem detection to implementation of the solution/combination.

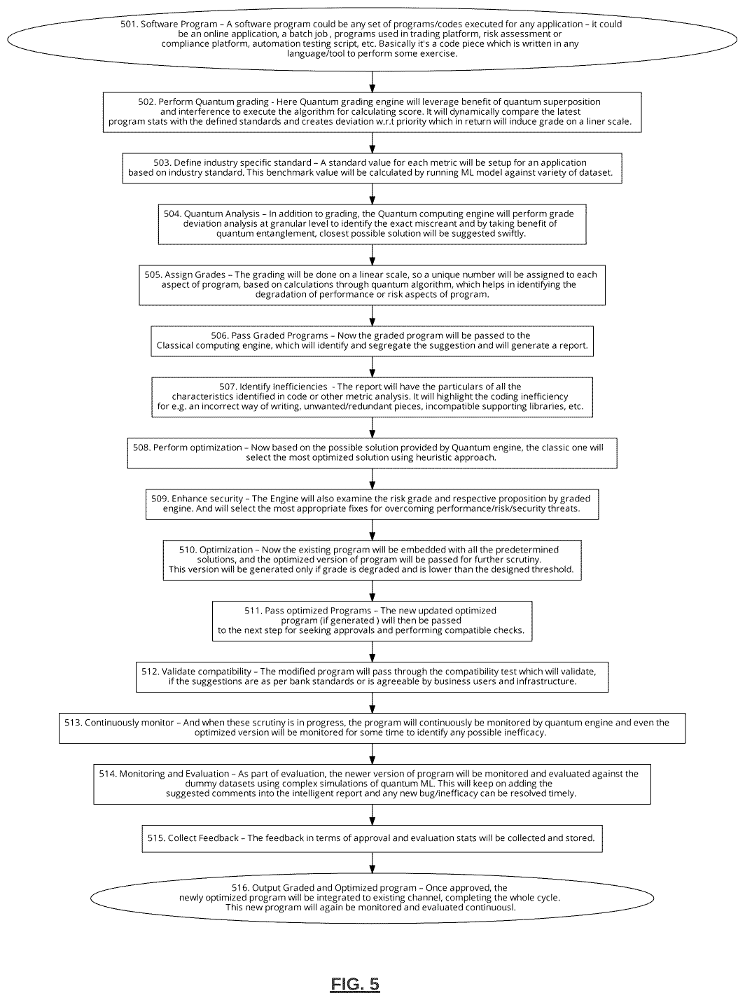

By way of non-limiting example, FIG. 5 depicts a sample, functional flow diagram discussing flow functionality in intermediate architecture detail and conceptually shows sample interactions, steps, functions, and components in accordance with one or more aspects of this disclosure.

501 explains that, in the context of this disclosure, a software program could be any set of programs/codes executed for any application-it could be an online application, a batch job, programs used in execution platform, security assessment or compliance platform, automation testing script, etc. Basically it's a code piece which is written in any language/tool to perform some exercise.

502 discusses the performance of quantum grading. Here a quantum grading engine in a quantum computer will leverage benefit of quantum superposition and interference to execute the algorithm for calculating score. It will dynamically compare the latest program stats with the defined standards and creates deviation w.r.t priority which in return will induce grade on a liner scale.

503 defines the industry specific standard. A standard value for each metric will be setup for an application based on industry standards. This benchmark value will be calculated by running ML model against variety of dataset.

504 discusses quantum analysis. In addition to grading, the quantum computing engine will perform grade deviation analysis at granular level to identify the exact miscreant and by taking benefit of quantum entanglement, closest possible solution will be suggested swiftly.

In 505, grades are assigned. The grading will be done on a linear scale, so a unique number will be assigned to each aspect of program, based on calculations through quantum algorithm, which helps in identifying the degradation of performance or risk aspects of program.

In 506, graded programs are passed. Now the graded program will be passed to the classical computing engine, which will identify and segregate the suggestion and will generate a report.

507 identifies inefficiencies. The report will have the particulars of all the characteristics identified in code or other metric analysis. It will highlight the coding inefficiency, for example, an incorrect way of writing, unwanted/redundant pieces, incompatible supporting libraries, etc.

508 addresses the optimization that is performed. Now based on the possible solution provided by quantum engine, the classic one will select the most optimized solution using heuristic approach.

509 addresses enhancement of security. The Engine will also examine the risk grade and respective proposition by graded engine. And will select the most appropriate fixes for overcoming performance/risk/security threats.

In 510, regarding optimization, now the existing program will be embedded with all the predetermined solutions, and the optimized version of program will be passed for further scrutiny. This version will be generated only if grade is degraded and is lower than the designed threshold.

In 511, optimized programs may be passed. The new updated optimized program (if generated) will then be passed to the next step for seeking approvals and performing compatible checks.

512 is to validate compatibility. The modified program will pass through the compatibility test which will validate, if the suggestions are as per bank standards or is agreeable by business users and infrastructure.

513 is to continuously monitor. When the scrutiny is in progress, the program will continuously be monitored by quantum engine and even the optimized version will be monitored for some time to identify any possible inefficacy.

In 514, for monitoring and evaluation, the newer version of program will be monitored and evaluated against the test datasets using complex simulations of quantum ML. This will keep on adding the suggested comments into the intelligent report and any new bug/inefficacy can be resolved timely.

In 515, feedback is collected. The feedback in terms of approval and evaluation stats will be collected and stored.

516 is for output graded and optimized program. Once approved, the newly optimized program will be integrated to existing channel, completing the whole cycle. This new program will again be monitored and evaluated continuously.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. An automated, hybrid-computing, quantum-infused, optimization process for monitoring, grading, and enhancing software comprising the steps of:
detecting, by a quantum computing engine (QCE), non-optimal software;
identifying, by the QCE, program metrics to analyze the non-optimal software;
prioritizing, by the QCE, the program metrics into prioritized metrics;
determining, by the quantum engine, industry standard values for the program metrics;
executing, by the QCE, a regression artificial-intelligence (AI) model on the industry standard values to identify thresholds;
encoding, by the QCE, the prioritized metrics, the industry standard values, and the thresholds into threshold qubits;
capturing, by the QCE, runtime statistics for the non-optimal software;
encoding, by the QCE, the runtime statistics into runtime qubits;
generating, by a quantum grading circuit using quantum superposition and interference, a linear score for the non-optimal software based on the runtime qubits;
comparing, with a quantum comparison circuit, the linear score and the threshold qubits in order to generate output qubits;
decoding, by the QCE, the output qubits into graded metrics;
receiving, by an optimization engine from the QCE, the graded metrics;
analyzing, by the optimization engine, granular deviation of the graded metrics by a comparison with the historical grades and the thresholds in order to identify a problem metric;
identifying, by the neural network model based on existing solutions, possible code-fix solutions for improving the non-optimal software to solve the problem metric;
performing, by the optimization engine, node structure analysis based on the possible code-fix solutions, existing code patterns, and code scanned from the non-optimal software, in order to identify proposed code fixes;
calculating, by the optimization engine using a quantum approximation algorithm, code weights for the proposed code fixes based on optimization improvement and cost efficiency; and
recommending, by the optimization engine based on the code weights, one or more best code fixes to reduce the granular deviation to zero.

2. The process of claim 1 further comprising the step of: identifying, by the neural network model, possible infrastructure solutions for improving the non-optimal software to solve the problem metric.

3. The process of claim 2 further comprising the step of: calculating, by the optimization engine using the quantum approximation algorithm, infrastructure weights for the possible infrastructure solutions based on said optimization improvement and said cost efficiency.

4. The process of claim 3 further comprising the step of: recommending, by the optimization engine based on the infrastructure weights, one or more best infrastructure fixes to reduce the granular deviation to zero.

5. The process of claim 4 further comprising the step of: generating, by the optimization engine, a visualization of the non-optimal software that needs optimization.

6. The process of claim 5 wherein the visualization includes identification of said one or more best code fixes and said one or more best infrastructure fixes.

7. The process of claim 6 further comprising the step of: generating, by the optimization engine based on the one or more best code fixes, an optimized software version.

8. The process of claim 7 further comprising the step of validating, by the optimization engine, compatibility of the optimized software version.

9. The process of claim 8 further comprising the step of validating, by the optimization engine, security of the optimized software version.

10. The process of claim 9 further comprising the step of integrating, by the optimization engine, the optimized software version into a runtime environment in place of the non-optimal software.

11. The process of claim 10 wherein the quantum grading circuit generates the linear score in accordance with a mathematical function defined as: 5/Wₙ*[Σ(|Xₘ−Xₜ|)/Xₜ*100)*P)/Tₘ*100], wherein: Xₘ=Actual measured value; Xₜ=True value of metric; P=Metric priority; Tₘ=Total count of metrics; and Wₙ=Worst score for total metrics. 12 The process of claim 11 wherein the linear score for the non-optimal software is graded against disparate behaviors of performance, risk, security, and cost.

13. The process of claim 12 further comprising the step of continuously monitoring and evaluating, by the QCE, the optimized software version in the runtime environment.

14. The process of claim 13 wherein the quantum computing engine is implemented in a quantum computer and the optimization engine is implemented in a non-quantum computer.

15. An automated, hybrid-computing, quantum-infused, optimization process for monitoring, grading, and enhancing software comprising the steps of:
detecting, by a quantum computing engine (QCE), non-optimal software;
identifying, by the QCE, program metrics to analyze the non-optimal software, said program metrics including at least response time, memory usage, and CPU usage;
prioritizing, by the QCE, the program metrics into prioritized metrics;
determining, by the QCE based on execution of a machine-learning model against historical industry data, industry standard values for the program metrics;
executing, by the QCE, a regression artificial-intelligence model on the industry standard values to identify thresholds;
encoding, by the QCE, the prioritized metrics, the industry standard values, and the thresholds into threshold qubits;
capturing, by the QCE, runtime statistics for the non-optimal software;
encoding, by the QCE, the runtime statistics into runtime qubits;
generating, by a quantum grading circuit using quantum superposition and interference, a linear score for the non-optimal software based on the runtime qubits such that a unique number is assigned to each aspect of the non-optimal software to help identify degradation of performance and security risks;
comparing, with a quantum comparison circuit, the linear score and the threshold qubits in order to generate output qubits;
decoding, by the QCE, the output qubits into graded metrics;
receiving, by an optimization engine from the QCE, the graded metrics;
analyzing, by the optimization engine, granular deviation of the graded metrics by a comparison with the historical grades and the thresholds in order to identify a problem metric;
identifying, by the neural network model based on existing solutions, possible code-fix solutions for improving the non-optimal software to solve the problem metric;
identifying, by the neural network model, possible infrastructure solutions for improving the non-optimal software to solve the problem metric;
performing, by the optimization engine, node structure analysis based on the possible code-fix solutions, existing code patterns, and code scanned from the non-optimal software, in order to identify proposed code fixes;
calculating, by the optimization engine using a quantum approximation algorithm, weights for the proposed code fixes and the possible infrastructure solutions based on optimization improvement and cost efficiency;
selecting, by the optimization engine based on the weights, one or more of said proposed code fixes and/or said possible infrastructure solutions to reduce the granular deviation to zero;
generating, by the optimization engine, a visualization of the non-optimal software that needs optimization along with identification of said proposed code fixes and said possible infrastructure solutions that were selected;
generating, by the optimization engine based on the one or more of said proposed code fixes that were selected, an optimized software version;
validating, by the optimization engine, compatibility and security of the optimized
integrating, by the optimization engine, the optimized software version into a runtime environment in place of the non-optimal software; and
continuously monitoring and evaluating, by the QCE, the optimized software version in the runtime environment.

16. The process of claim 15 wherein the quantum grading circuit generates the linear score in accordance with a mathematical function defined as: 5/Wₙ*[Σ(|Xₘ−Xₜ|)/Xₜ*100)*P)/Tₘ*100], wherein: Xₘ=Actual measured value; Xₜ=True value of metric; P=Metric priority; Tₘ=Total count of metrics; and Wₙ=Worst score for total metrics.

17. The process of claim 16 wherein the quantum computing engine is implemented in a quantum computer and the optimization engine is implemented in a non-quantum computer.

18. An automated, hybrid-computing, quantum-infused, optimization process for monitoring, grading, and enhancing software comprising the steps of:
detecting, by a quantum computing engine (QCE), non-optimal software;
identifying, by the QCE, program metrics to analyze the non-optimal software, said program metrics including at least response time, memory usage, and CPU usage;
prioritizing, by the QCE, the program metrics into prioritized metrics;
determining, by the QCE based on execution of a machine-learning model against historical industry data, industry standard values for the program metrics;
executing, by the QCE, a regression artificial-intelligence model on the industry standard values to identify thresholds;
encoding, by the QCE, the prioritized metrics, the industry standard values, and the thresholds into threshold qubits;
capturing, by the QCE, runtime statistics for the non-optimal software;
encoding, by the QCE, the runtime statistics into runtime qubits;
generating, by a quantum grading circuit using quantum superposition and interference, a linear score for the non-optimal software based on the runtime qubits such that a unique number is assigned to each aspect of the non-optimal software to help identify degradation of performance and security risks;
comparing, with a quantum comparison circuit, the linear score and the threshold qubits in order to generate output qubits;
decoding, by the QCE, the output qubits into graded metrics;
receiving, by an optimization engine from the QCE, the graded metrics;
analyzing, by the optimization engine, granular deviation of the graded metrics by a comparison with the historical grades and the thresholds in order to identify a problem metric;
identifying, by the neural network model based on existing solutions, possible code-fix solutions for improving the non-optimal software to solve the problem metric;
identifying, by the neural network model, possible infrastructure solutions for improving the non-optimal software to solve the problem metric;
performing, by the optimization engine, node structure analysis based on the possible code-fix solutions, existing code patterns, and code scanned from the non-optimal software, in order to identify proposed code fixes;
calculating, by the optimization engine using a quantum approximation algorithm, weights for the proposed code fixes and the possible infrastructure solutions based on optimization improvement and cost efficiency;
selecting, by the optimization engine based on the weights, one or more of said proposed code fixes and/or said possible infrastructure solutions to reduce the granular deviation to zero;
generating, by the optimization engine, a visualization of the non-optimal software that needs optimization along with identification of said proposed code fixes and said possible infrastructure solutions that were selected;
generating, by the optimization engine based on the one or more of said proposed code fixes that were selected, an optimized software version;
validating, by the optimization engine, compatibility and security of the optimized
integrating, by the optimization engine, the optimized software version into a runtime environment in place of the non-optimal software; and
continuously monitoring and evaluating, by the QCE, the optimized software version in the runtime environment, wherein the quantum computing engine is remote from the optimization engine that is local.

19. The process of claim 18 wherein the quantum computing engine is implemented in a quantum computer and the optimization engine is implemented in a classical computer.

20. The process of claim 19 wherein the quantum grading circuit generates the linear score in accordance with a mathematical function defined as: 5/Wₙ*[Σ(|Xₘ−Xₜ|)/Xₜ*100)*P)/Tₘ*100], wherein: Xₘ=Actual measured value; Xₜ=True value of metric; P=Metric priority; Tₘ=Total count of metrics; and Wₙ=Worst score for total metrics.
